(19) United States
(12) Patent Application Publication
(10) Pub. No.: US 2010/0303055 A1
(43) Pub. Date: Dec. 2, 2010

(54) Method for Assigning Data Messages to Time Slots in a Wireless Data Bus System Having Hidden Subscribers

(75) Inventors: Frank LAHNER, Erlangen (DE); Peter THAMM, Weinheim (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/789,777

(22) Filed: May 28, 2010

(30) Foreign Application Priority Data
May 29, 2009 (EP) EP 09161516

(51) Int. Cl. H04J 3/00

(52) U.S. Cl. 370/345

(57) ABSTRACT

A method for assigning data messages to time slots in a wireless data bus system having hidden subscribers (“hidden nodes”), wherein each subscriber is initially assigned at least one time slot for exclusive use per transmission cycle and the time slot can be engaged by another subscriber for use in the event of non-use by the subscriber. Moreover, an engagement matrix is provided which records, for each subscriber, those time slots of other subscribers for which engagement is permitted in a data message cycle. In accordance with the invention, the engagement matrix is configured to block at least the engagement of the time slot of another subscriber for a subscriber if it is another subscriber (“hidden node”) that cannot be reached by radio by the subscriber.

### BACKGROUND OF THE INVENTION

1. Field of the Invention

The invention relates to a method for assigning subscribers in a wireless data bus network to time slots in transmission cycles for the data messages in a data bus network.

2. Description of the Related Art

In wireless data bus networks, various methods are used to control access by individual communication subscribers to time slots which are available during the data transmission cycles. Wireless data bus networks involve attempts to attain the most collision-free possible engagement of the time slots with data messages from the individual communication subscribers. In principle, a distinction is drawn between two types of access methods for the purpose of organizing the message traffic.

A first type of access method involves an exclusive access right to a channel or time slot being granted for each communication subscriber. The time slots available in the data transmission cycles are thus each permanently assigned to a particular subscriber. These access methods are also called time-division multiplex methods or Time Division Multiple Access (TDMA). Based on the thus granted exclusive access for each communication subscriber to its own time slot, there is assurance that there are no simultaneous transmissions by different subscribers and hence no access conflicts and message destruction. This is assured even when a wireless data bus network involves communication subscribers for which there is no radio link to one another due to the topological structure of the network or because of temporary shadowing. Such pairs of subscribers, which are “hidden” in radio terms and which cannot “hear” one another, are also referred to as “hidden nodes”. Although such subscribers can each send data messages to a third subscriber, such as to a central gateway, they cannot observe the transmission activities of other “hidden nodes”.

Access methods based on the TDMA principle advantageously have not only absolute freedom from collision but also a deterministic cycle time, i.e., there is maximum latency for the transmission of a message. This has the contrasting drawback that the average latency is designed for the maximum possible data traffic and hence cannot be reduced even when data traffic is temporarily weak or low.

A second type of access method allows, in principle, all the communication subscribers to access a channel or the time slots available in the data transmission cycles simultaneously and to attempt to transmit data messages therein. These access methods are also called Carrier Sense Multiple Access (CSMA) and Carrier Sense Multiple Access with Collision Avoidance (CSMA/CA). To avoid collisions, subscribers wishing to access a channel or time slot simultaneously intially monitor the current time slot for a short waiting time to ensure that the time slot has not in the meantime been engaged by another subscriber to transmit a data message. If it is not possible to find any radio transmission by another subscriber at the end of the waiting time, the “listening” subscriber assumes that the time slot is free and engages it by transmitting its own data.

Despite this measure, collisions cannot be ruled out completely, even if the probability thereof is relatively low, since such a case occurs only if two communication subscribers actually start to send data at the same time. The message destruction which occurs in this case is recognized by the transmitters by virtue of missing acknowledgements from the communication receiver, e.g., a network coordinator in the form of a gateway. On account of the need to repeat the failed transmission of the messages, however, large time delays arise.

An advantage of these methods is that the latencies are very short in a wireless communication network in the event of a low load. A disadvantage is that, when the channel load is high, the latencies can become very long due to the repetitions of messages, and it is not possible to determine a maximum latency. This problem is exacerbated if a data transmission network operated in this manner contains “hidden nodes”, i.e., at least one pair of subscribers which, in the event of the transmission of a message to a third subscriber, cannot hear one another. In the case of such subscribers, collisions arise not only in the rare case of simultaneous message starts. On the contrary, they can disturb the transmission by the other subscriber at any time, since they cannot “hear” one another. This significantly increases the frequency of occurences of relatively long latencies.

In radio-based wireless data bus networks, which are used for industrial communication, the data transmission needs to meet the requirements of determinism and real-time capability. The data transmission thus needs to have been concluded in such good time that it is process-compatible, i.e., the execution of a technical process is not disturbed thereby. Furthermore, the maximum cycle times which occur need to be able to be calculated and thus to be as short as possible. Finally, latencies need to be as short as possible, and messages need to be transported via different communication paths with as little delay as possible.

To meet requirements of this type, access methods are frequently used which are a combination of TDMA and CSMA methods. This allows the advantages of TDMA methods, preferably the deterministics thereof, and CSMA methods, preferably the short mean latencies, to be combined. Methods of this type are specified in the Institute of Electric and Electronic Engineers (IEEE) standard 802.15.4, for example. Combined access methods produce only a minimal level of added communication complexity and can advantageously be used for “energy-self-sufficient sensors”, i.e., energy-saving sensors, such as with a local power supply comprising a battery, in automation and process engineering. These methods can also be configured such that dynamic matching to variable connections in the relevant wireless data bus networks is possible, such as matching to movable subscribers, variable channel properties, such as shadowing or gain.

In such a combined access method, the time slots that are available in a data transmission cycle admittedly have a stipulation regarding which subscribers can have the respective time slots, i.e., which subscribers may transmit data exclusively in which time slots. In this context, it is not absolutely necessary for all time slots in the cycle to have been assigned, i.e., there may also be free time slots present. However, if one of the subscribers does not exercise its right to data transmission in the assigned time slot of a data transmission cycle, such as because there are no data for transmission, it is possible for other communication subscribers to engage this time slot competitively on a dynamically changing basis.

A combined access method of the above type allows both the maximum latency of a deterministic system to be implemented and, when engagement is not one hundred percent, the mean latency to be reduced. If there are “hidden nodes” in such a network, however, the advantage of the reduced mean latency can be re-lost if two subscribers attempt to engage a time slot which is not being used by an exclusive user simultaneously and hence cause a collision. A particular problem with such a method is that neither the two transmitters which cannot hear one another nor the receiver know which subscribers are “hidden”. It may even occur that the transmitter is disturbed by a “hidden node” while it is using its exclusive time slot.

### SUMMARY OF THE INVENTION

It is therefore an object of the invention to provide a wireless data bus network which allows combined assignment of subscribers to time slots in a cycle based on the (TDMA) method, i.e., deterministic communication, and based on the Carrier Sense Multiple Access (CSMA) method, i.e., fast event-controlled communication, such that access conflicts and hence mistransmissions can be avoided even when “hidden nodes” are present.

This and other objects and advantages are achieved in accordance with the invention by providing a method in which access to the time slots by the subscribers in a wireless data bus network is coordinated per transmission cycle using an engagement matrix. This is used to reciprocally deny subscribers which cannot reach one another by radio, i.e., subscribers are “hidden nodes” and hence cannot recognize when the time slot of the respective other subscriber is engaged. Here, respective access to the time slice is assigned to the other subscriber for exclusive use. As a result, it is possible to avoid collisions, occurring statistically more often, which result from a subscriber not being able to detect, due to an interruption in radio contact, that a subscriber is sending data in the exclusively assigned time slot and instead inadvertently assuming that the time slot has become free through non-use.

In an embodiment of the invention, for such subscribers, the time slots which are still free in the engagement matrix, i.e., which are neither assigned nor blocked for exclusive use, are additionally distributed over the two subscribers explicitly without overlaps. This allows even statistically more rarely occurring collisions to be avoided, in which two subscribers which cannot reach one another by radio make simultaneous attempts to engage the time slot of another subscriber which has become free through non-use.

Advantageously, the method in accordance with the invention is performed by a central network interface, e.g., by a gateway which all subscribers can reach by radio, i.e., which is not a “hidden node”. This central network interface manages and possibly updates the inventive engagement matrix automatically at stipulated times, and hence organizes the collision-free allocation of the time slots to the communication subscribers for each message cycle. Consequently, the structure of each message cycle, e.g., the time slice cycle, is defined in a collision-free manner. The engagement matrix firstly records what subscribers have been permanently assigned which time slot for exclusive use and secondly what subscribers cannot reach one another by radio, i.e., cannot “hear” one another and need to be reciprocally decoupled from one another by appropriate access blocks to the time slots of the “invisible” partner. That portion of the engagement matrix relevant to each subscriber in a data bus network is transmitted from the network coordinator to all subscribers. In the event of a free or freed time slot, this reveals to said subscribers whether or not they have authorization to engage this time slot.

The disclosed embodiments of the invention advantageously permit the use of a combination of methods to significantly reduce latencies associated with sending data messages in a data bus network with a combination of TDMA and CSMA/CA access methods.

There are various practices available for forming and possibly updating the engagement matrix.

Thus, a first embodiment involves a central network interface, for example, firstly sending a special transmission request to a selected subscriber, requesting the subscriber to send a data message as a test in a particular time slice, particularly in the time slice which is assigned to the subscriber for exclusive use. Secondly, all other subscribers in the wireless data bus system are requested to attempt to receive the data message transmitted in this time slice. If one of the other subscribers is unable to receive a data message in this time slice, both subscribers cannot reach one another by radio, i.e., there is a “hidden nodes” situation between the selected subscriber and the non-receiving subscriber. The non-receiving subscriber then generates a data message with an appropriate indication and sends the message in the time slot exclusively assigned to it to the central network interface. In accordance with the disclosed embodiments of the invention, the thus automatically detected pair of subscribers which cannot reach one another by radio (“hidden nodes”) is then recorded in the engagement matrix in the manner described above. It should be appreciated that this method step can also be performed with other subscribers so as to cover any other subscribers which cannot reach one another by radio.

The presently contemplated embodiment of the method can advantageously be performed at system startup and advantageously permits the identification of a multiplicity of “hidden nodes” even before the actual startup of a data bus network, and possible collisions can be avoided from the outset. Alternatively, the method can be performed or repeated during productive operation to regularly update the engagement matrix under some circumstances. If appropriate, the engagement matrix can also be reset before an update. As a result, it is possible to prevent pairs of effectively virtual “hidden stations” from being permanently recorded in the engagement matrix after the occurrence of only temporary radio interruptions. Here, it would even be possible for the case to arise in which after a certain time the engagement matrix no longer has any unblocked combinations of subscribers. Engagement of unused time slots by other subscribers based on the contemplated embodiments of the CSMA/CA access method would then be permanently no longer permitted and the advantage of the combination of TDMA and CSMA access methods would be lost.

In another embodiment, the detection of subscribers which cannot be reached by radio (“hidden nodes”) and hence the inventive filling of the engagement matrix can also occur in accordance with the disclosed embodiments of the invention during ongoing operation of a data bus network by dynamically recognizing and analyzing collisions. If the transmission of the data message from one subscriber in a time slot has been disturbed, the subscriber can recognize this from the absence of feedback, particularly from the central network interface, signaling the error-free acknowledgement of the transmission. In the subsequent data message, which is transmitted from this subscriber preferably in the next time slot assigned for exclusive use, the number of the time slot in which the erroneous transmission occurred is then additionally transmitted. It is therefore known which subscriber has this time slot exclusively assigned to it. The sending subscriber and the holder of the relevant time slice are then “hidden stations”. Depending on the occurrence of collision cases, it is therefore possible to configure the engagement matrix in accordance with the disclose embodiments of the invention described above on a piece-by-piece basis. The contemplated embodiment has the advantage over purely time-controlled embodiments in that the engagement matrix can immediately, in the event of a collision occurring, have the causal “hidden node” situation added, but with the discontinuation of a collision in turn not being detected immediately. Therefore, both methods can also be used in combination.

The method in accordance with the contemplated embodiments of the invention is advantageous particularly when the wireless data bus network does not contain static subscribers or when movements occur in the vicinity of subscribers, such as when large objects are transported on conveyor belts. In such cases, “hidden node” situations can arise dynamically between subscribers and can be effectively compensated for by the disclosed embodiments of the method in accordance with the invention. If, in such a case, the surroundings in which the wireless data bus network is being used adopt different states, it is also possible to manage a plurality of special engagement matrices optimized therefor and to activate them depending on the state of the installation. A particular advantage is the use of the contemplated embodiments of the method in accordance with the invention even for data bus networks in which a merely low throughput of data messages occurs relatively often (low channel load). Thus, exclusively assigned time slots can be released by the respective subscribers and hence engaged by other subscribers relatively often. In addition, the contemplated embodiments of the method in accordance with the invention can also advantageously be used for data bus networks which have a relatively large number of subscribers. Here, the number of time slots per transmission cycle and hence the cycle times are large anyway in this context. Consequently, it is advantageous to use the contemplated embodiments of the method in accordance with the invention to prevent, as far as possible, data messages from being destroyed by collisions between subscribers which cannot be reached by radio.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and advantageous embodiments thereof are explained with reference to examples which are shown in the Figures indicated briefly below, in which:

FIG. 1 shows an exemplary illustration of two data transmission cycles having time slots which are assigned to subscribers A-F for exclusive use;

FIG. 2 shows an exemplary illustration of an access collision on time slots in a transmission cycle, where one subscriber inadvertently accesses the time slot of another subscriber, assigned for exclusive use, simultaneously;

FIG. 3 shows an exemplary illustration, for comparison with FIG. 2, where the method in accordance with the invention is implemented to prevent a collision;

FIG. 4 shows an exemplary illustration of a further access collision, where two subscribers inadvertently access a freed time slot of another subscriber simultaneously;

FIG. 5 shows an exemplary illustration, for comparison with FIG. 4, where the method in accordance with the invention is implemented to prevent a collision;

FIG. 6 shows an exemplary illustration of an engagement matrix for a message structure corresponding to FIG. 5, where it is assumed that the subscribers B and E cannot reach one another by radio;

FIG. 7 is an exemplary further transmission cycle, where, even in the case of two pairs of subscribers that cannot reach another by radio, the method of the invention can be used to prevent collisions;

FIG. 8 shows an exemplary illustration of an engagement matrix for a message structure corresponding to FIG. 7, where it is assumed that the subscribers B, E and A, C cannot reach one another by radio; and

FIG. 9 is a flow chart of the method in accordance with an embodiment of the invention.

### DETAILED DESCRIPTION OF THE PRESENTLY PREFERRED EMBODIMENTS

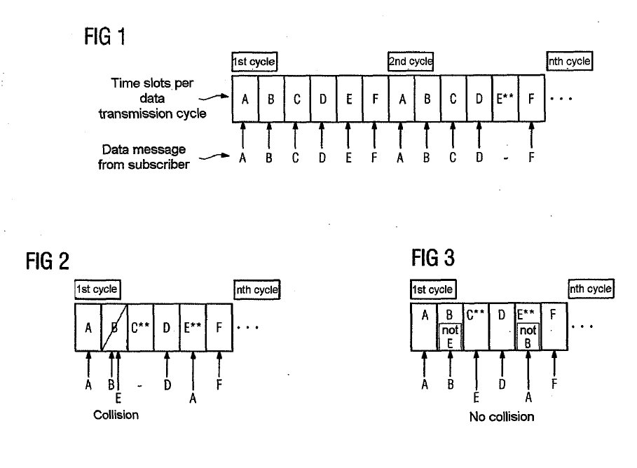

FIG. 1 shows a detail from a data transmission with two exemplary data transmission cycles. The transmission of data in a wireless data bus network is naturally a continuous chain of such data transmission cycles. This is symbolized in FIG. 1 and the subsequent Figures by an nth cycle in addition to exemplary 1st and 2nd cycles.

In the example of FIG. 1, it can be assumed that the underlying data bus network contains not only a central station but also six subscribers A-F, and each of the subscribers A-F has been assigned exactly one time slot A-F for exclusive use. Here, the 1st cycle involves each subscriber A-F transmitting user data in the exclusively assigned time slot A-F, whereas the 2nd cycle involves time slot E being unused, for example, since subscriber E currently has no data for transmission. In this TDMA access method, although access collisions between subscribers are ruled out in all cases, one drawback is that temporarily freed time slots remain unused, such as time slot E in the 2nd cycle in FIG. 1.

FIG. 2 shows an exemplary illustration of an access collision on time slots in a transmission cycle, where one subscriber inadvertently accesses the time slot of another subscriber, assigned for exclusive use, simultaneously. Here, it is assumed that there is a “hidden node” situation between subscribers B and E, and time slots C and E have been released by the exclusively assigned subscribers. Since, in contrast to the example in FIG. 1, the data transmission in the example in FIG. 2 involves the use of a combined TDMA and CSMA access method, access collisions cannot be ruled out at first. In the example in FIG. 2, the result of the inability to rule out access collisions is that subscriber E erroneously attempts to send in time slot B, without noticing that subscriber B exclusively assigned this time slot has not released the time slot and likewise wishes to transmit data. By contrast, subscriber A, which is visible to all other subscribers by radio, can additionally engage a freed time slot for further data transmission, in the example time slot E**, without collision.

Such collisions can be avoided using the method in accordance with the invention. This is explained with reference to FIG. 3, which shows an example which is comparable to FIG. 2. Here, there is also a “hidden node” situation between subscribers B and E, and time slots C and E have been released by the exclusively assigned subscribers. Based on the method in accordance with the invention, however, the “hidden node” partners are known to subscribers B, E and are recorded as appropriate in the engagement matrix. Time slot B is marked “not E”. Accordingly, the engagement by the permanently assigned subscriber B is not disturbed. Instead, the searching subscriber E engages the next free time slot C** without collision. In addition, nothing about the engagement of the free time slot E** by A changes. The method in accordance with the invention can thus be used to avoid frequently occurring access conflicts of the type described above.

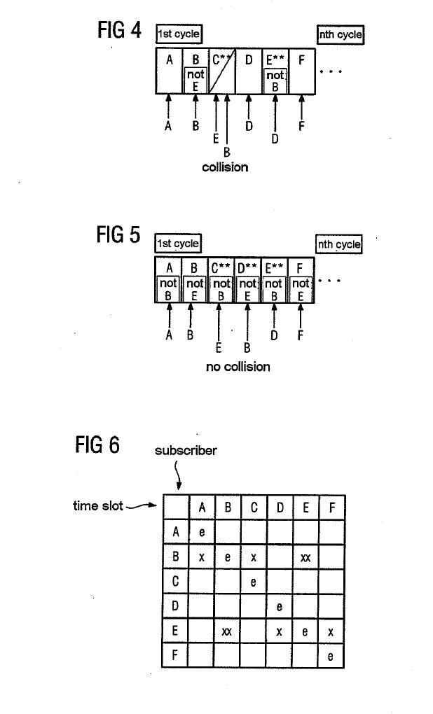

Nevertheless, there are rarely occurring exceptional situations in which a further type of access conflict can arise. FIG. 4 shows an example of a corresponding access collision. Here, it is also assumed that there is a “hidden node” situation between subscribers B and E, and time slots C and E have been released by the exclusively assigned subscribers. In addition, it has been assumed that both “hidden nodes” B, E have an increased volume of data transmission. That is, both are effectively searching for the next free time slot. Since they cannot reach one another by radio, however, both now simultaneously attempt to access the freed time slot C** of subscriber C and cause a collision. By contrast, the free time slot E** is engaged by subscriber D without any problems. Although this time slot is marked “not B”, it can be engaged by D, since there is no “hidden node” situation between E and D in the example.

In an advantageous embodiment, the method in accordance with the invention is also used to avoid this type of access collision. This is explained with reference to the continuing FIG. 5, which shows an example which is comparable to FIG. 4. Here, those time slots not yet provided with “blocking annotations” in FIG. 4 are also distinguished accordingly. These time slots are effectively explicitly divided between the two “hidden node” subscribers in this case. Thus, in the example, time slots A, C** are now also marked “not B”, that is to say can be engaged by subscriber E if required. Accordingly, time slots D and F are now also marked “not E” in the example, that is to say can be engaged by subscriber B if required. Based on this additional division, it is also possible to avoid collisions in the manner of FIG. 4. The shared attempt by subscribers E and B to access the freed time slot C**—which attempt still collides in FIG. 4—is divided in FIG. 5 into orderly access by subscriber E to the freed time slot C** (“not B”) and access by subscriber B to the freed time slot D** (“not E”).

FIG. 6 shows an exemplary illustration of an engagement matrix for a message structure corresponding to that in FIG. 5, where it is assumed that subscribers B and E cannot reach one another by radio. Here, the rows are assigned to subscribers A-F and the columns are assigned to the provided time slots A-B. In addition, the marker “e” in the diagonal of the engagement matrix shows that subscriber A, for example, has naturally been assigned its “own” time slot A permanently and for priority data transmission. In addition, fields with “xx” symbolize access blocks in the case of a “hidden node” situation and therefore correspond to the markers in the example in FIG. 3. Thus, time slot B in the second column of the engagement matrix in FIG. 6 cannot be engaged by subscriber E as per the fifth row. Conversely, time slot E in the fifth column of the engagement matrix cannot be engaged by subscriber B as per the second row. As a result, it is possible to avoid access conflicts in line with the type illustrated in the example in FIG. 2.

In addition, the further time slots are divided between the two subscribers B, E in the engagement matrix as per rows 2 and 5. This is symbolized by appropriate engagement blocks “x”. Thus, time slots A, C are additionally blocked in the second row for subscriber B, and accordingly time slots D and F are additionally blocked in the fifth row for subscriber E. This allows collisions as per the example in FIG. 4 to be avoided, corresponding to the markers in FIG. 5.

The method in accordance with the contemplated embodiment of the invention can be used even when more than one time slot is permanently assigned for an actively communicating subscriber, or in principle unassigned, vacant time slots are present in each transmission cycle. Advantageously, the engagement matrix is managed by a central element in a data bus network, e.g. by a gateway which all subscribers can reach by radio.

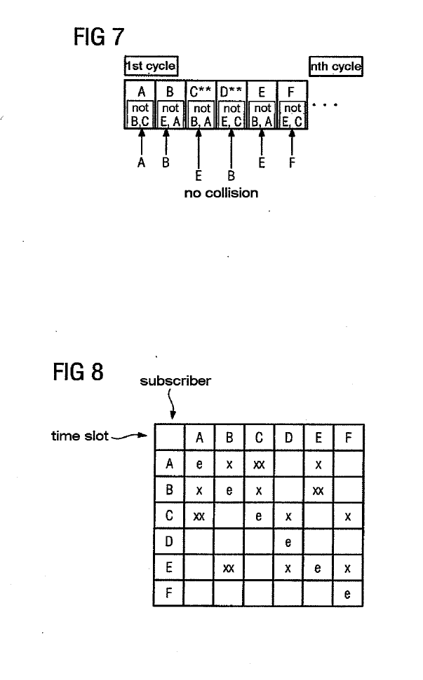

The method in accordance with the contemplated embodiments of the invention can be used even if a wireless data bus network should contain more than one pair of subscribers which cannot reach one another by radio. FIG. 7 shows an example of an appropriate transmission cycle, where collisions can be avoided using the embodiments of the invention even if there are two pairs of subscribers which cannot reach one another by radio. Here, it can be assumed that there is a respective “hidden node” situation between subscribers B, E and A, C. FIG. 8 shows an exemplary illustration of an appropriate engagement matrix for the message structure corresponding to that in FIG. 7. This matrix is formed, in principle, based on the same scheme as already explained above. Thus, in FIG. 8, the entries associated with subscribers B, D, E and F match those in the engagement matrix from FIG. 6. Due to the second “hidden node” pair A, C, the associated time slots in rows 1 and 3 of the engagement matrix in FIG. 8 have entries extended in line with the disclosed embodiments of the method of the invention. Thus, time slot C of subscriber C is naturally blocked for subscriber A (see entry “xx” in row 1, column 3), and conversely time slot A of subscriber A is blocked for subscriber C (see entry “xx” in row 3, column 1). In addition, the remaining time slots have been divided for subscribers A, C in the manner described above (see entries with “x” in rows 1 and 3 of the engagement matrix in FIG. 8).

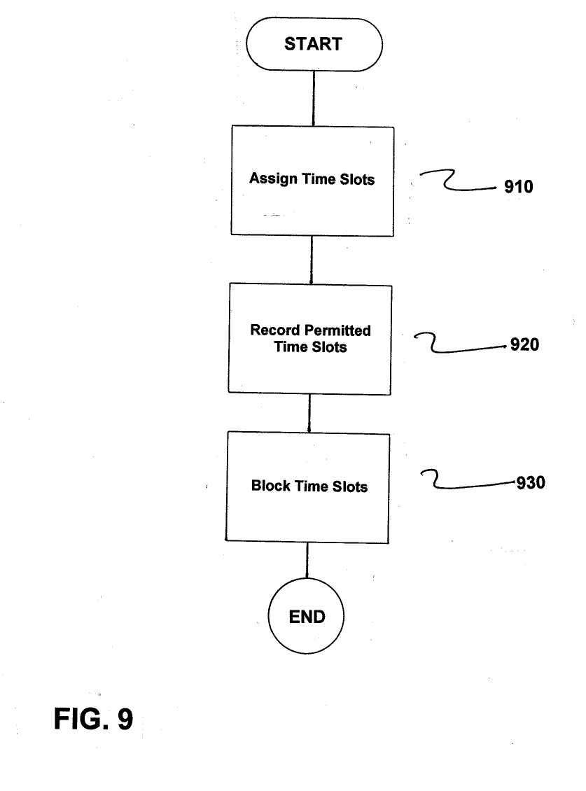

FIG. 9 is a flow chart of the method for assigning subscribers in a wireless data bus network to a time slots in transmission cycles for data messages in a data bus network. The method comprises assigning each subscriber at least one time slot for exclusive use per transmission cycle, the time slot being engageable by another subscriber for use in an event of non-use by the subscriber, as indicated in step 910. For each subscriber, time slots of other subscribers for which engagement is permitted in a data message cycle are recorded in an engagement matrix, as indicated in step 920. At least an engagement of the time slot of an additional subscriber for the subscriber if the additional subscriber is unable to be reached by radio is blocked at the engagement matrix, as indicated in step 930.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A method for assigning subscribers in a wireless data bus network to time slots in transmission cycles for data messages in a data bus network, the method comprising:
assigning each subscriber at least one time slot for exclusive use per transmission cycle, said time slot being engageable by another subscriber for use in an event of non-use by the subscriber;
recording, in an engagement matrix, for each subscriber, time slots of other subscribers for which engagement is permitted in a data message cycle; and
blocking, in the engagement matrix, at least an engagement of the time slot of a first subscriber by a second subscriber if the first subscriber is unable to reach the second subscriber by radio.

2. The method as claimed in claim 1, wherein remaining time slots which are one of unassigned for exclusive use and unblocked are divided between first and second subscribers.

3. The method as claimed in claim 1, wherein first and second subscribers are hidden node with respect to each other.

4. The method as claimed in claim 1, wherein the wireless data bus network includes a central subscriber reachable by radio by all of the subscribers in the data bus network, said method further comprising forming the engagement matrix by:
prompting, by the central server, a selected subscriber to send a data message as a test;
prompting, by the central subscriber, all other subscribers as waiting subscribers in the data bus network to receive the data message sent as the test,
issuing a notification from said waiting subscribers to the central subscriber if said waiting subscribers have not received the data message sent as the test after a waiting time has elapsed; and
reciprocally blocking, at the central server, engagement of time slots of the selected subscriber for said waiting subscribers in the engagement matrix that have not received the data message.

5. The method as claimed in claim 2, wherein the wireless data bus network includes a central subscriber reachable by radio by all of the subscribers in the data bus network, said method further comprising forming the engagement matrix by:
prompting, by the central server, a selected subscriber to send a data message as a test;
prompting, by the central subscriber, all other subscribers as waiting subscribers in the data bus network to receive the data message sent as the test,
issuing a notification from said waiting subscribers to the central subscriber if said waiting subscribers have not received the data message sent as the test after a waiting time has elapsed; and
reciprocally blocking, at the central server, engagement of time slots of the selected subscriber for said waiting subscribers in the engagement matrix that have not received the data message.

6. The method of claim 4, wherein the selected subscriber and said waiting subscribers comprise hidden nodes with respect to each other.

7. The method as claimed in claim 4, wherein the engagement matrix is reset before forming the engagement matrix.

8. The method as claimed in claim 4, wherein said forming the engagement matrix is performed repeatedly in a cyclical manner.

9. The method as claimed in claim 7, wherein said forming the engagement matrix is performed repeatedly in a cyclical manner.

10. The method as claimed in claim 1, wherein the wireless data bus network includes a central subscriber that is reachable by radio by all subscribers in the data bus network, and said method further comprises forming the engagement matrix by:
transmitting, by a sending subscriber, a first data message to the central subscriber in a time slot which has been assigned to another subscriber for exclusive use;
awaiting, by the sending subscriber, an expiration of a time to await transmission of confirmation of a successful receipt of the first data message;
notifying, by the sending subscriber, the central subscriber, in a second data message, of the time slot of the another subscriber provided for transmission of the first data message if no confirmation of the successful receipt of the first data message is received after expiration of the time; and
reciprocally blocking, by the central subscriber, engagement of the time slots of the sending subscriber and the another subscriber for said subscribers in the engagement matrix.

11. The method as claimed in claim 3, wherein the wireless data bus network is configured to assume different operating states in which at least one of other groups of subscribers and subscribers in an altered physical arrangement are active, and wherein said different operating states are assigned a different engagement matrix.

12. The method as claimed in claim 10, wherein the wireless data bus network is configured to assume different operating states in which at least one of other groups of subscribers and subscribers in an altered physical arrangement are active, and wherein said different operating states are assigned a different engagement matrix.

13. The method as claimed in claim 1, wherein subscribers unable to reach each other by radio comprise hidden nodes with respect to each other.

14. The method as claimed in claim 3, wherein the central subscriber is a gateway.

15. The method as claimed in claim 10, wherein the central subscriber is a gateway.

16. The method as claimed in claim 6, wherein the sending subscriber and the another subscriber comprise hidden nodes with respect to each other.
